(19) United States
(12) Patent Application Publication
(10) Pub. No.: US 2026/0217604 A1
(43) Pub. Date: Jul. 30, 2026

(54) CEMENTITIOUS, SELF-BINDING MATERIAL WITH REDUCED OR NO CEMENT

(71) Applicant: KING ABDULLAH UNIVERSITY OF SCIENCE AND TECHNOLOGY, Thuwal (SA)

(72) Inventors: Khabiboulakh KATSIEV, Thuwal (SA); Illia SHEVCHENKO, Thuwal (SA)

(21) Appl. No.: 19/142,688

(22) PCT Filed: Feb. 21, 2024
(86) PCT No.: PCT/IB2024/051665

§ 371 Date: Jun. 24, 2025

Related U.S. Application Data
(60) Provisional application No. 63/448,428, filed on Feb. 27, 2023.

(51) Int. Cl. C04B 18/02; C04B 14/06; C04B 28/18; C04B 40/02; C04B 111/10

(52) U.S. Cl. CPC C04B 18/021; C04B 14/068; C04B 28/188; C04B 40/024; C04B 2111/1037; C04B 2201/20; C04B 2201/52

(57) ABSTRACT

A cementitious material includes activated sand, which has a fresh surface area of at least 60% of a total surface area, inorganic crosslinkers, each being a chain of calcium, silicon and oxygen atoms, and cement up to 5% by weight of a total mass of the cementitious material. The inorganic crosslinkers bond sand grains to each other, and the fresh surface area is not present in raw sand from which the activated sand is obtain by disintegration.

### CROSS-REFERENCE TO RELATED APPLICATIONS

This application claims priority to U.S. Provisional Patent Application No. 63/448,428, filed on Feb. 27, 2023, entitled “CEMENTITIOUS, SELF-BINDING MATERIAL WITH REDUCED OR NO CEMENT,” the disclosure of which is incorporated herein by reference in its entirety.

### BACKGROUND OF THE INVENTION

### Technical Field

Embodiments of the subject matter disclosed herein generally relate to a cementitious material and method for making the cementitious material with less or no cement, and more particularly, to a process of activating sand through mechanical disintegration and/or abrasion, mixing the activated sand with a lime based material, and curing the obtained composition at a given temperature and pressure, above the room temperature and pressure, to form the cementitious material that has no cement or a small amount of cement, but has a physical strength larger than a traditional cement based material.

### Discussion of the Background

Portland cement is one of the most commonly used construction materials in the world, but its impact on the environment is becoming increasingly concerning. The production of Portland cement is energy-intensive and results in the release of large amounts of carbon dioxide (CO₂) into the atmosphere, contributing to global warming and climate change.

The production of Portland cement is a multi-step process, which is described by the America's Cement Manufacturers as being a closely controlled chemical combination of calcium, silicon, aluminum, iron and other ingredients.

Common materials used to manufacture the cement include limestone, shells, and chalk or marl combined with shale, clay, slate, blast furnace slag, silica sand, and iron ore. These ingredients, when heated at high temperatures form a rock-like substance, which is then ground into the fine powder that is commonly thought as cement.

The most common way to manufacture Portland cement is through a dry method. The first step of this method is to quarry the principal raw materials, mainly limestone, clay, and other materials. After quarrying, the rock is crushed. This involves several stages. The first crushing reduces the rock to a maximum size of about 6 inches. The rock then goes to secondary crushers or hammer mills for reduction to about 3 inches or smaller. The crushed rock is combined with other ingredients, such as iron ore or fly ash, and then ground, mixed, and fed to a cement kiln.

The cement kiln heats all the ingredients to about 1,500 degrees Celsius in huge cylindrical steel rotary kilns lined with special firebrick. Kilns are frequently as much as 12 feet in diameter and longer, in many instances, than the height of a 40-story building. The large kilns are mounted with the axis inclined slightly from the horizontal. The finely ground raw material or the slurry is fed into the higher end. At the lower end is a roaring blast of flame, produced by precisely controlled burning of powdered coal, oil, alternative fuels, or gas under forced draft. As the material moves through the kiln, certain elements are driven off in the form of gases. The remaining elements unite to form a new substance called “clinker.” Clinker comes out of the kiln as grey balls, about the size of marbles.

Clinker is discharged red-hot from the lower end of the kiln and generally is brought down to handling temperature in various types of coolers. The heated air from the coolers is returned to the kilns, a process that saves fuel and increases burning efficiency. After the clinker is cooled, cement plants grind it and mix it with small amounts of gypsum and limestone. Cement is so fine that 1 pound of cement contains about 150 billion grains. The cement is now ready for transport to ready-mix concrete companies to be used in a variety of construction projects.

The heating process described above releases large amounts of CO₂, which is why the production of Portland cement is one of the largest contributors to industrial CO₂ emissions. According to the International Energy Agency, the production of cement is responsible for approximately 7% of global CO₂ emissions. The use of the Portland cement has also led to environmental degradation and resource depletion. The quarrying of raw materials destroys habitats, disrupts wildlife, and depletes natural resources. In addition, the production process requires large amounts of energy, water, and other resources, further exacerbating the environmental impact of cement production.

In response to the negative impacts of Portland cement, alternative cementitious materials (i.e., materials that include little or absolutely no cement, but have a strength comparable if not higher to that of the cement-based products) are being developed and researched. One such alternative is the geopolymer cement, which is made from industrial waste materials, such as fly ash, slag, and pozzolanic materials. The production of geopolymer cement produces significantly less CO₂ compared to the production of Portland cement, and the use of waste materials reduces the demand for raw materials and reduces waste.

Another alternative to the Portland cement is the magnesium oxide cement, which is made from magnesium oxide and magnesium chloride. Magnesium oxide cement is stronger than Portland cement and sets faster, reducing the amount of energy required for production. Additionally, magnesium oxide cement has a lower carbon footprint, as it produces fewer CO₂ emissions during production compared to Portland cement. However, these alternatives are expensive.

Thus, there is a need for environmentally friendly materials, that are not energy intensive, minimize the CO₂ generation, do not destroy habitats, and do not disrupt wildlife and are also inexpensive.

### SUMMARY OF THE INVENTION

According to an embodiment, there is a cementitious material that includes activated sand, which has a fresh surface area of at least 60% of a total surface area, inorganic crosslinkers, each being a chain of calcium, silicon and oxygen atoms, and cement up to 5% by weight of a total mass of the cementitious material. The inorganic crosslinkers bond sand grains to each other, and the fresh surface area is not present in raw sand from which the activated sand is obtain by disintegration.

According to another embodiment, there is a cementitious material that includes activated sand, which has a fresh surface area of at least 60% of a total surface area and inorganic crosslinkers, each being a chain of calcium, silicon and oxygen atoms. The inorganic crosslinkers bond sand grains to each other, the fresh surface area is not present in raw sand from which the activated sand is obtain by disintegration, and the cementitious material is free of cement and has a hardness of about 600 to 1000 kg/cm² due to the inorganic glue.

According to yet another embodiment, there is a method for making a cementitious material, and the method includes receiving raw sand, disintegrating a surface of the raw sand to form activated sand, wherein the activated sand has a fresh surface area of at least 60% of the raw sand, mixing the activated sand with a lime-base product to form a mixture having calcium silicate hydrates on the fresh surface area, shaping the mixture into an intermediate product, and curing the intermediate product to form a final product in which sand grains are bonded to each other by inorganic crosslinkers formed from the calcium silicate hydrates. The final product is free of cement and has a hardness of about 600 to 1000 kg/cm² due to the inorganic glue.

### BRIEF DESCRIPTION OF THE DRAWINGS

For a more complete understanding of the present invention, reference is now made to the following descriptions taken in conjunction with the accompanying drawings, in which:

FIG. 1A schematically illustrates the mechanical structure of the raw sand while FIG. 1B schematically illustrates the mechanical structure of activated sand obtained from the raw sand;

FIG. 2 is a flow chart of a method for producing a cementitious material from the raw sand;

FIG. 3 schematically illustrates the structure change experienced by the raw sand when transforming into the cementitious material;

FIGS. 4A and 4B schematically illustrate a disintegration system that transforms the raw sand into the activated sand; and

FIG. 5 is a schematic diagram of a plant that manufactures the cementitious material from the raw sand.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to pure sand, i.e., silica. However, the embodiments to be discussed next are not limited to pure sand, but may be applied to any sand-based material, i.e., sands having different chemical compositions, in addition to the silica.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

According to an embodiment, a novel process for making a cementitious material that requires little or no cement for achieving a high strength is discussed. A main difference between the traditional concrete, a conventionally used building material, and this new cementitious material is as follows: the concrete is comprised of two components (I) a binder, i.e., the cement material, and (II) sand resources, e.g., gravel, stones, sand, etc., that serve as a filler. Contrary to this traditional composition, the novel process and cementitious material needs no external binder component, i.e., it requires no cement. Of course, a certain amount of cement may be added to this process, but it is not required. This novel technology is based on the surface activation of the ordinary sand material. The technology facilitates the formation of calcium silicate hydrates (C-S-H) at the surface of the sand particles and the C-S-H chemical species serve as the binding/crosslinking agent, enabling the self-binding property of the ordinary sand. This process results in the agglutination of the otherwise chemically inert sand particles. Upon reaching a sufficient concentration of crosslinkers, the sand particle agglutination takes place.

The degree of agglutination of the sand particles is sufficient to make it suitable for building/construction technology. A wide range of construction materials can be produced with this novel technology: blocks, panels, beams etc. Structurally, the concrete can be categorized as a composite material, while the products generated with this novel technology is based on a single component, making the final products 30-40% cheaper. Furthermore, the novel cementitious material significantly reduces CO₂ emission and energy consumption associated with cement manufacturing as well as offers full recyclability of the construction material.

Before discussing this process in more detail, a couple of definitions are believed to be in order. The term “cementitious” is used herein as meaning a material that does not require any cement (not even a trace of cement) and still achieves bonding between the various grains of the material that are stronger than those achieved by cement-based materials. The cementitious material essentially includes only ordinary sand. However, as the ordinary sand is not pure, it can be expected that various impurities may be present in the ordinary sand. A small amount of cement may also be present, however this amount is smaller than in any known concrete products, i.e., less than 10 % by weight of the final product for a strength higher than a corresponding product that has more than 10% by weight.

The “ordinary sand” may be extracted from various regions of the world, and depending on its origin, the sand may have a different composition. The “sand” is defined herein as being a granular material of fine mineral particles, mainly silica. Because the sand can have different compositions, it is defined by its grain size. The most common constituent of the sand is silica, also known as silicon dioxide or SiO₂, which is usually in the form of quartz. The second most common constituent is the calcium carbonate, which has been created by various forms of life, for example, coral and shellfish. Some sands may also include calcium sulfate (e.g., gypsum), feldspar, amphibole, Al₂O₃, CaO, MgO, etc. Thus, the term “sand” is used herein to refer to a material that includes mainly silica, but may include other materials, depending on its origin. In one application, the term “sand” is understood to include at least 90% silicon oxide.

ISO 14688 grades sands as fine, medium, and coarse with ranges of 0.063 mm to 0.2 mm to 0.63 mm to 2.0 mm. In the United States, sand is commonly divided into five sub-categories based on size: very fine sand ( 1/16 -⅛ mm diameter), fine sand (⅛ mm-¼ mm), medium sand (¼ mm-½ mm), coarse sand (½ mm-1 mm), and very coarse sand (1 mm-2 mm). The embodiments discussed herein apply to any sand grade. It is noted that the desert sand is considered in the art as not being suited for concrete products because of its smooth and fine grains and thus, the surface chemistry of the desert sand cannot offer a sufficient number of multidirectional chemical linkages.

To overcome this problem, the inventors found that the fine grains of the desert sand (and for that reason, of any known sand) may be activated to produce enough chemical linkages so that it is possible to form an “inorganic glue” on the surface of the grains that is capable to glue together plural sand grains to each other, without the need of adding cement, i.e., the traditional bonding material. This is true for any type of sand, not only for the desert sand. In other words, the surface of the sand grains can be activated with the novel process as now discussed, no matter the origin, size, and composition of the sand. More specifically, the activation of the sand surface is achieved in this embodiment by mechanical disintegration (e.g., abrasion) of the sand grains. This activation step results in the formation of functional groups at the newly created surfaces and this is very different from the standard raw materials that are used together with cement for forming concrete.

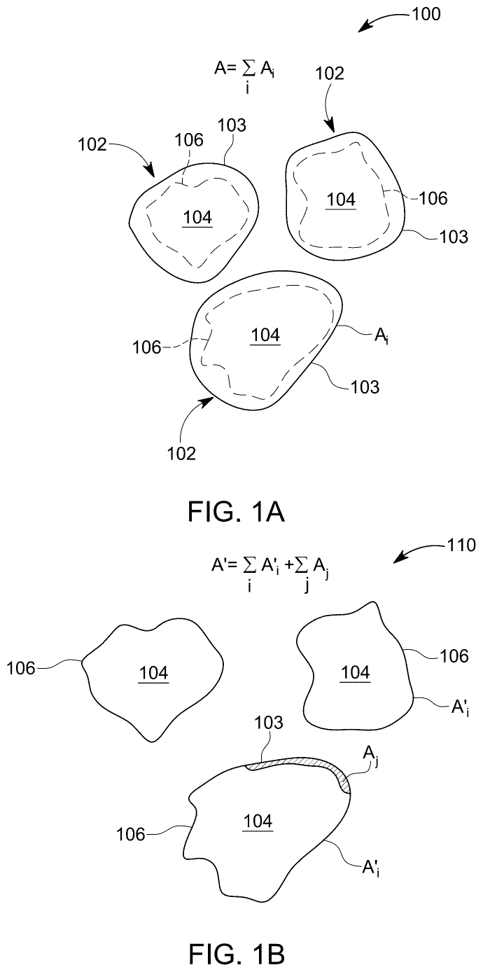

In this regard, FIG. 1A schematically illustrate a few grains 102 of raw sand 100. After the process of mechanical disintegration, the activated grains 104 that form the activated sand 110 are shown in FIG. 1B. The activated grains 104 have new surfaces 106, that were created in the mechanical disintegration step. It is noted that the new or activated surface 106 is not as smooth as the original surface 103 of the raw grains 102. To successfully activate the raw sand 100, the new surface 106's area (also called the freshly created surface area) in the activated sand 110 needs to be at least 60% of the original surface area of the raw sand 100. In other words, a given amount of raw sand 100 has a total surface area A, when the surface area Aᵢ of each grain 102 is counted. In this case, the total surface area A is given by the sum of all Aᵢ forming the raw sand 100. After the activation process discussed above, the total surface area A′ of the activated sand 110 is given by the sum of all new areas A′ᵢ, i.e., the activated surfaces, and the sum of the old areas Aⱼ that were not activated, where i and j are integers that correspond to the total number of grains of sand in the given raw sand 100. Note that a given sand grain 104 may have a combination of an activated area A′ᵢ and a non-activated area Aⱼ, as schematically illustrated in FIG. 1B. Also note that it is possible that some grains have no non-activated area Aⱼ. The inventors discovered that the condition for achieving enough disintegration of the areas of the sand to form enough strong bonds without cement is given by: A′≥ΣᵢAᵢ≥0.6A′, i.e., the freshly formed total surface area ΣᵢA′ᵢ is between 60 and 100% of the total surface area of all the activated sand grains.

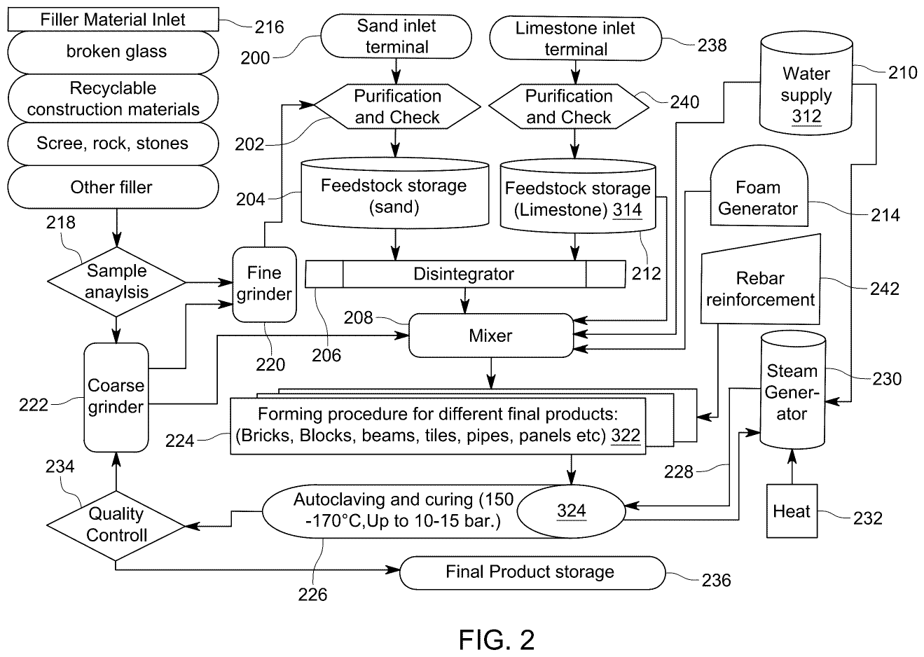

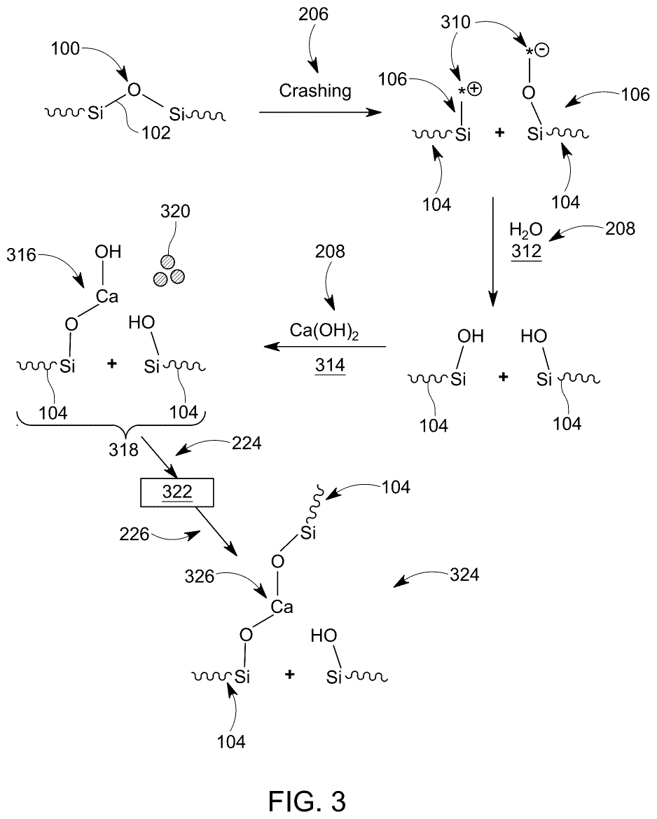

A method for producing a cementitious building material based on the sand activation process illustrated in FIGS. 1A and 1B is now discussed with regard to FIGS. 2 and 3. While these figures illustrate the manufacturing of a building material, the same steps apply to a process of manufacturing a non-building material. FIG. 2 is a flow chart of the method. In step 200, a quantity of sand resources, e.g., raw sand 100, is received. The raw sand 100 can be any type of sand, including but not limited to sand that is not appropriate for current cement based concrete processes, e.g., desert sand. In step 202, the sand or sand resources are purified, i.e., debris that are not typically found in the sand are removed by various processes, for example, sieving, low temperature calcination, etc. and then the quality of the sand is checked. In step 204, the sand resource 100 is transported to the location where the disintegration process is performed, if the previous steps were not already performed at that location.

In step 206, the surface of the sand resource 100 is activated through a mechanical disintegration process, as explained above in regard to FIG. 1B. A system for achieving the mechanical disintegration process is discussed later. In one application, in which desert sand was used as the sand resource, and before the disintegration step 206, the sand grains 102 may be in the range of 2-3 mm to 40-60 micron. After the disintegration step, the grain size distribution may narrow down significantly-most of the particles are less than 200 micron. However, as previously discussed with regard to FIG. 1B, a more versatile measure of the degree of disintegration required (sufficient) for the production of the abovementioned cementitious materials is the percentage of the freshly created surface area. The percentage of a freshly created surface area is given with respect to the total surface area of the raw material, and must be in the range of 60-100%. A freshly created surface is chemically active and governs the formation of inorganic crosslinkers, for example, the calcium silicate hydrate (C-S-H) species. Thus, this measure is independent of an initial particle size of the raw material, i.e., ordinary sand. The density of the material produced by deploying this method is about 2280 kg/m³ vs 2,400 kg/m³ for concrete, the surface area is about 5.7 m²/g, and the pore size is about 8nm. The term “about” is used in this document to mean a variation of up to 20%, either positive or negative.

This step 206 of crashing the sand resource 100 is schematically illustrated in FIG. 3, and results in the electrically positive and negative charges 310 being formed on the surface 106 of the grains 104. In step 208, the activated grains 104 are mixed with (1) water 312 and (2) a lime-based product 314, as schematically illustrated in FIGS. 2 and 3, to form a mixture 318. The lime-based product 314 is a calcium-containing inorganic material that includes oxides and/or hydroxides of Ca. The water 312 may be added first and then the lime-based product 314, as illustrated in FIG. 3, or the two products may be added simultaneously, as illustrated in FIG. 2. FIG. 2 shows a water tank 210 and a feedstock storage tank 212 storing the water and lime product, respectively, used in step 208. FIG. 2 also indicates that the lime-based product 314 may be mixed with the sand resource 100 in the disintegrator system, prior to adding the water 312.

Mixing the raw sand 100 with the lime-based product 314, for example, caustic lime, enables the surface chemical reactions illustrated in FIG. 1B, resulting in the formation of calcium silicate hydrates (C-S-H) species 316, as schematically illustrated in FIG. 3. The C-S-H species 316 include at least one of calcium silicate hydrate (i.e., a mixture of CaO, SiO₂, and H₂O) and calcium hydroxide (Ca(OH)₂).

The C-S-H species 316 on the surface 106 of the grains 104 serve as the “inorganic glue,” which ensures that the grains stick together when cured and generate a strength of the final product that is superior to the cement-based materials. Such an internal glue, when present in sufficient quantities, enables self-binding of the sand particles, resulting in agglutination. As discussed above, the sand resource 100 used in this industrial process can be an ordinary sand (e.g., desert sand), the construction sand from the sand quarry, riverbed, or the recycled sand from the products previously produced by the technology described herein. In one application, the mix formulation required for production of construction products is 90 wt % of the activated sand 110 and 10 wt % of the limestone or caustic lime 314. An alternative mix formulation may be: 90 wt % of the activated sand 110, 10 wt % of limestone or caustic lime 314, and up to 5 wt % of (conventionally used) cement 320, on the expense of reducing the amount of limestone or caustic lime 314. The addition of the cement 320 may take place in step 208. Note that the addition of the cement 320 is optional and the final product 324 may include no cement or just traces of cement, for example, less than 0.1 wt % of the final product 324.

Additional elements may be added in step 208, for example, foaming agents 214, recycled fillers 216, e.g., broken glass, recyclable construction materials, rock stones, etc. If the recycled fillers 216 are used, they will be sample analyzed in step 218, fine grinded in step 220 and/or coarse grinded in step 222 or both, and then either introduced to step 202 or to step 208 into the process illustrated in FIG. 2.

In step 224, the mixture 318 obtained after the mixing step 208, which presents as a powder, is casted into the final shape, for example, in a mold, and the resulting intermediate product 322 may be in the form of blocks, panels, beams, tiles, paves, pipes, etc., i.e., the shape of any construction material. In one application, this step also includes vibrational or mechanical pressing treatments to remove as many air bubbles as possible. In step 226, the intermediate product 322 is autoclaved and cured in an enclosed chamber, so that the temperature is about 150 to 170° C., and the pressure may be up to 10-15 bar. This step of drying, which may take up to 24 hours, results in the final product 324, which is schematically illustrated in FIG. 3. FIG. 3 shows the formation of the crosslinkers 326 between adjacent sand grains 104 and this crosslinker acts as the bonding glue, which is the prerogative of the cement in the traditional concrete products. However, in this embodiment, there is no need for the cement. The crosslinker 326 is defined herein as including a chain of atoms bonded to each other, and the chain includes at least Si, O, Ca, O, Si atoms in this specific order.

Note that in this embodiment, the final product 324, i.e., the cementitious material, has no cement. However, in another embodiment, the cementitious material 324 may include up to 5% by weight cement 320. It is further noted that during this step of curing, steam 228 is generated in a steam generator device 230, and the steam is injected into the drying chamber for generating the high temperature used for curing. The steam generator 230 may use any heat source 232, for example, heat from a power plant.

The final cementitious material 324 is then checked in step 234 for determining its strength. If the strength or hardness is in the range of 600-1000 kg/cm², which is the expected hardness for this novel material, the material is stored in step 236 in a storage facility. Note that the hardness of the conventionally produced concrete products is in the range from 200 to 500 kg/cm². If the hardness of the obtained material 324 is not meeting the range noted above, the product is sent to the coarse grinder step 222 for being recycled. It is noted that any failed product does not ends up in the trash, as the failed concrete products do, but can be easily recycled by grinding.

The lime-based product 314 is received in step 238 and its then purified in step 240 before being supplied to the mixer in step 206. The foaming agents 214 discussed above may be generated with a traditional foam generator, similar to the one conventionally used in the construction industry for the production of an aerated concrete-in case of production of aerated (or other types of porous) insulation blocks. In step 224, depending on the type of final product intended to be obtained, rebar 242 may be added prior to the step 226 of currying, to further strengthen the final product. If rebar is added, note that during the curing step 226, because of the high temperature inside the curing chamber, the rebar increases its length and the intermediate product 322 cures around the extended rebar. When the curing process is over, the final product is cooled to room temperature, which means that the rebar contracts to reclaim its original length, which essentially results in compressing the cementitious material 324, i.e., obtained a compressed cementitious material, which is the equivalent of the compressed concrete, i.e., has an increase strength.

One skilled in the art would understand that the only step where heat is used in the process illustrated in FIG. 2 is the curing step 226, but the curing temperature is so low comparative to the 1500° C. required in the cement fabrication process, that almost no CO₂ is generated by this process. Further, such a low temperature may be achieved with solar panels, or with recycled steam from a power plant to further minimize the CO₂ footprint. Thus, the final cementitious product 324 is not only stronger than the traditional concrete, but it is much greener and cheaper than the concrete.

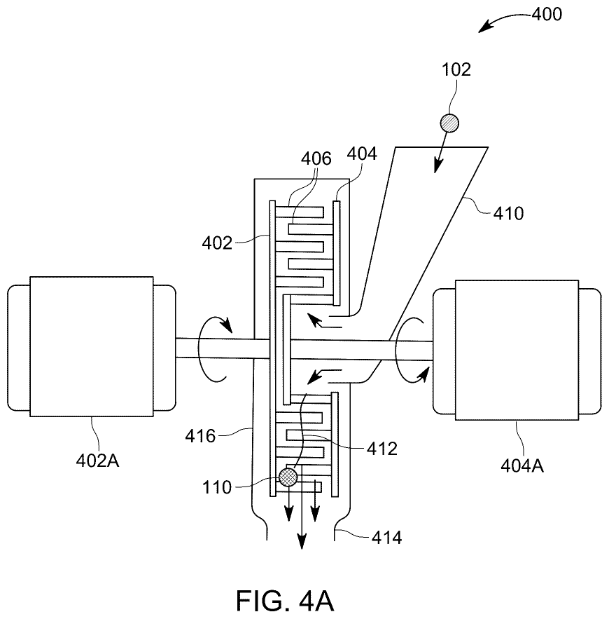

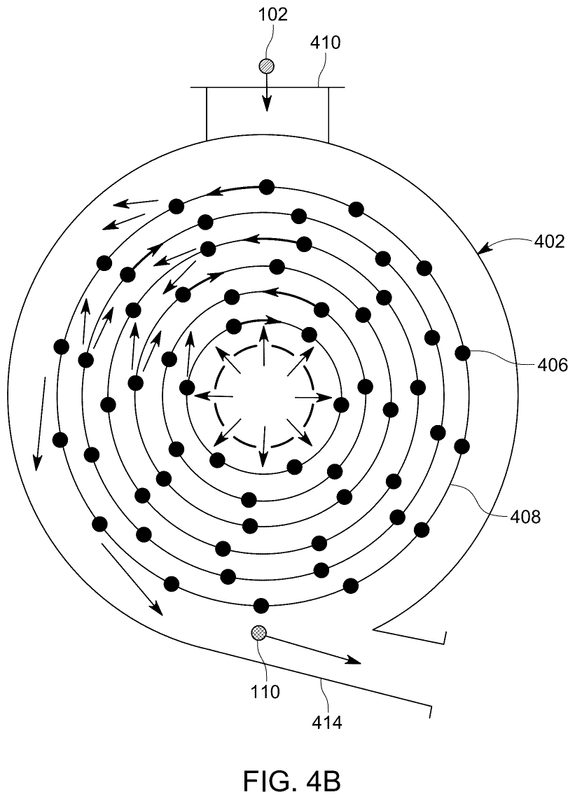

One possible implementation of a disintegrator system 400 used in step 206 is illustrated in FIG. 4A, and includes first and second disks 402 and 404 facing each other, each disk having plural metal rods 406 that extend away from their corresponding disks. The metal rods are attached to the disks 402 and 404 following a certain pattern, for example, circles 408 with increasing radius, as shown in FIG. 4B. Other patterns may be used. FIG. 4A shows that the plural metal rods extend from the corresponding disk so that each metal rod from one disk is surrounded by metal rods from the other disk. In this way, a sand grain 102 that enters the feed inlet 410 is supplied to the space defined by the two disks (which are vertically arranged in this embodiment), and then the grain 102 travels along a path 412, extending from the center of the disks to their circumference, until being discharged as activated sand 110 at the product outlet 414. During this travelling time, the sand grain mechanically interacts with the metal rods 406 and its surface is activated, i.e., the grain is roughened up by the metal rods 406. Each of the metal disk 402 and 404 is rotated by a corresponding motor 402A and 404B, and the two disk are rotated in opposite directions. The disks are protected by a housing 416, which also prevents the activated sand grains to be ejected before the outlet 414.

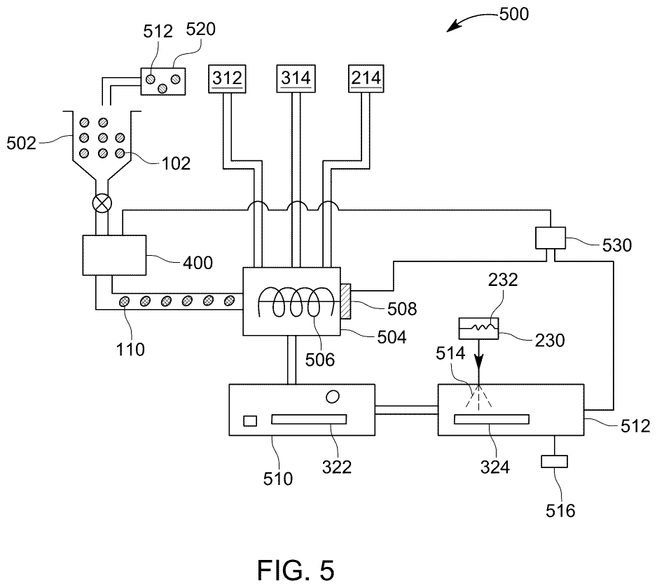

A cementitious building material plant 500 that uses the above noted technology is schematically illustrated in FIG. 5. The plant 500 includes a raw sand supply tank 502 that holds the raw sand 102. The raw sand 102 may be purified before being loaded into the supply tank 502. From here, the raw sand 102 is supplied to the disintegrator system 400 for activating its surface and transforming it into the activated sand 110. From here, the activated send 110 is transported to the mixer 504, which has one or more paddles 506 that are rotated by an electrical motor 508. The mixer 504 mixes the activated sand 110 with one or more of the water 312, lime based product 314, and/or foaming agent 214. Each of these components are stored into a corresponding tank. After the mixing phase, the intermediate product 322 is provided into a mold chamber 510, where the product is placed in various molds and shaped to become the desired building material. Next, the intermediate product 322 shaped as desired enters a curing chamber 512, where a certain temperature and pressure is established. A steam generator 230, which is heated by a heater 232, generates steam 514, which is injected into the curing chamber 512, to achieve the desired temperature. A pump 516 may be used to pump air inside the curing chamber for achieving the desired pressure. In one application, the steam may be used to achieve both the desired temperature and pressure. The final product 324 is then removed from this room and stored at another location.

The plant 500 may produce, with no cement, many types of building materials that traditionally are made with cement. As previously discussed, although the plant can operate with no cement, if desired, a certain amount of cement may be added. In this case, the foaming agent 214 may be replaced or enhanced with cement and provided to the mixer 504. Any amount of cement may be added to the intermediate product 322. However, the plant 500 is designed to operate with zero amount of cement. Although the plant 500 was discussed in the context of manufacturing building materials, those skilled in the art would understand that non-building materials may be manufactured using the same technology and the raw sand 102. For example, ornamental objects, like statutes, columns, etc. may be build with the plant 500. In one embodiment, a grinding system 520 may be provided for grinding recyclable material 522, which then can be added to the raw sand 102. The grinding system 520 may include a coarse grinder and a fine grinder and the recyclable material may include glass, rocks, stones, discharged building material like old concrete, etc. The plant may also have a controller 530, which is connected to the various units discussed above, and the controller may automatically regulate the speed of the disks in the disintegration system 400, the quantities to be mixed in the mixer 504, the pressure and temperature in the curing chamber 512, etc.

The disclosed embodiments provide a process and material that uses no concrete or a very small amount of concrete, which makes the process to avoid the usage of high temperature, e.g., over 300° C. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention.

However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A cementitious material comprising:
activated sand which has a fresh surface area of at least 60% of a total surface area;
inorganic crosslinkers, each being a chain of calcium, silicon and oxygen atoms; and
cement up to 5% by weight of a total mass of the cementitious material,
wherein the inorganic crosslinkers bond sand grains to each other, and
wherein the fresh surface area is not present in raw sand from which the activated sand is obtain by disintegration.

2. The cementitious material of claim 1, wherein the cement is up to 0.1 % by weight.

3. The cementitious material of claim 1, wherein the raw sand is desert sand.

4. The cementitious material of claim 1, wherein the inorganic crosslinkers are formed from calcium silicate hydrates present on the fresh surface area of the activated sand, and the calcium silicate hydrates are a mixture of CaO, SiO₂, and H₂O.

5. The cementitious material of claim 4, wherein the activated sand is about 90% by weight, and the calcium silicate hydrates are up to 10% by weight.

6. The cementitious material of claim 1, wherein the fresh surface area is an area that does not exist in the corresponding raw sand.

7. The cementitious material of claim 1, having a hardness of about 600 to 1000 kg/cm² due to the inorganic crosslinkers.

8. The cementitious material of claim 1, having a density of about 2280 kg/m³ and a surface area of about 5.7 m²/g.

9. A cementitious material comprising:
activated sand, which has a fresh surface area of at least 60% of a total surface area; and
inorganic crosslinkers each being a chain of calcium, silicon and oxygen atoms
wherein the inorganic crosslinkers bond sand grains to each other,
wherein the fresh surface area is not present in raw sand from which the activated sand is obtain by disintegration, and
wherein the cementitious material is free of cement and has a hardness of about to 1000 kg/cm² due to the inorganic glue.

10. The cementitious material of claim 9, wherein the raw sand is desert sand.

11. The cementitious material of claim 9, wherein the inorganic crosslinkers have a chemical structure Si—O—Ca—O—Si.

12. The cementitious material of claim 9, wherein the fresh surface area is an area that does not exist in the raw sand.

13. The cementitious material of claim 9, wherein the activated sand is about 90% by weight.

14. The cementitious material of claim 9, having a density of about kg/m³ and a surface area of about 5.7m²/g.

15. A method for making a cementitious material, the method comprising:
receiving raw sand;
disintegrating a surface of the raw sand to form activated sand, wherein the activated sand has a fresh surface area of at least 60% of the raw sand;
mixing the activated sand with a lime-base product to form a mixture having calcium silicate hydrates on the fresh surface area;
shaping the mixture into an intermediate product; and
curing the intermediate product to form a final product in which sand grains are bonded to each other by inorganic crosslinkers formed from the calcium silicate hydrates,
wherein the final product is free of cement and has a hardness of about 600 to 1000 kg/cm² due to the inorganic glue.

16. The method of claim 15, wherein the step of curing comprises:
heating the intermediate product to about 150 to 170° C.; and
pressurizing the intermediate product at about 10 to 15 bars.

17. The method of claim 15, wherein the raw sand is desert sand.

18. The method of claim 15, wherein the fresh surface area is an area that does not exist in the raw sand.

19. The method of claim 15, wherein the activated sand is about 90% by weight, and the lime-based product is about 10% by weight.

20. The method of claim 15, further comprising:
exposing the intermediate product to steam during the curing step.
